(19) United States
(12) Patent Application Publication
(10) Pub. No.: US 2023/0222405 A1
(43) Pub. Date: Jul. 13, 2023

(54) MOBILE APPLICATION AND DATABASE FOR INDEPENDENT CONTRACTOR MULTI-SERVICE SCHEDULING AND PAY SCALE, AND METHOD FOR USE

(71) Applicant: Kwame Francis-John, Brookline Village, MA (US)

(72) Inventor: Kwame Francis-John, Brookline Village, MA (US)

(21) Appl. No.: 18/180,555

(22) Filed: Mar. 8, 2023

Related U.S. Application Data
(63) Continuation of application No. 17/445,414, filed on Aug. 19, 2021.
(60) Provisional application No. 62/706,812, filed on Sep. 11, 2020.

(51) Int. Cl. G06Q 10/10

(52) U.S. Cl. CPC G06Q 10/06311; G06Q 30/0282; G06Q 10/06315; G06Q 10/105; G06Q 10/0639; G06Q 10/063114

(57) ABSTRACT

A system and method for displaying a plurality of tasks from a client device to a server device, wherein the client device, in response to an indication of availability from the server device, receives task data for each of the plurality of tasks, including information indicative of a valuation rate of each task determined via a client device, wherein the valuation may be a set value of a timer-related value. Actions by the server device regarding completion and/or cancellation of previous tasks can modify the valuation rate.

### CROSS-REFERENCE TO RELATED APPLICATION

This application claims the benefit of priority of U.S. provisional application No. 62/706,812, filed 11 Sep. 2020, the contents of which are herein incorporated by reference. This application claims the benefit of priority of U.S. non-provisional application No. 17/445,414, filed 19 Aug. 2021, as a continuation thereof, the contents of which are herein incorporated by reference.

### BACKGROUND OF THE INVENTION

The present invention relates to human resources software, and more particularly to a mobile application and database for Independent Contractor multi-service scheduling and pay scale, and method for use.

Independent Contractors are currently unable to provide services for set prices or on a flat fee basis and provide services at an hourly rate at the same time.

There is no existing pay scale that enables fixed fee and hourly rate services to be provided concurrently. Independent Contractors are not provided an opportunity to perform work on both a fixed fee basis and/or an hourly price at the same time. Independent Contractors are often underpaid and enjoy no consistency in hiring and payment.

A fee structure and scheduling tool is needed to provide a reasonable pay scale and enable Independent Contractors to earn more income and provide better opportunities for Independent Contractors to produce more work. A way to enable increased production by Independent Contractors on both a per hour and a fixed fee basis is needed to provide cost effective and efficient assistance for Customers of Independent Contractors.

As can be seen, there is a need for a solution to one or more of these problems.

### SUMMARY OF THE INVENTION

In one aspect of the present invention, a method for presenting a display of one or more tasks, the method including the following: in response to an indication of availability from a server device, receiving, at one or more processors in the server device, task data for each of the one or more task, including information indicative of a valuation rate of each task determined via a client device; presenting, by the one or more processors, the display of the one or more task and the valuation rate, based on the task data; and for each of the one or more tasks: receiving, at the one or more processors, an indication of a proximity relative to a radius area determined via a user interface of the server device; and presenting, by the one or more processors, a proximity indication of each task corresponding to the radius area, the proximity indication identifying a location of each task within the radius area.

The server device and the client device may be computers, as described further disclosed herein, that communicate across a shared network.

In another aspect of the present invention, the above-mentioned method for presenting a display of one or more tasks, further including: receiving, at the one or more processors, an indication of a time quantity and/or an amount quantity of the valuation rate determined via the client device; for each task, receiving, at the one or more processors, indications of cancellation status and completion status; and for each task, presenting, by the one or more processors, an indications of a cancellation status and a completion status, wherein the client device and the server device are both configured to modify the cancellation status, and/or server modify the completion status, wherein the completion status is modifiable between an incomplete condition and a completed condition, wherein the cancellation status is modifiable between an uncancelled condition and a cancelled condition, wherein said valuation rate is a function of one or more completion statuses consecutively modified to the completed condition, wherein the completed condition prompts the client device to provide a confirmation of completion, wherein the provided confirmation of completion prompts the client device to provide a review, wherein the provided review changes said valuation rate, and wherein said valuation rate is a function of one or more cancellation statuses modified to the cancelled condition.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of the present invention;

FIG. 2 is a block diagram of an exemplary embodiment of the present invention; and

FIG. 3 is a pay scale chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system comprising a mobile application and database for Independent Contractor multi-service scheduling and pay scale, and method for use.

The embodiments described herein with reference to the accompanying drawings, in which like reference numerals may refer to identical or functionally similar elements, and descriptions below are provided for the purpose of describing aspects of the present invention. Further, the terminology used herein is for the purpose of describing particular embodiments only and is not intended to be limiting of the disclosed embodiments. As used herein, the singular forms “a,” “an,” and “the” are included to include the plural forms as well, unless context clearly defines otherwise. It will be further understood that the terms “comprises” and/or “comprising,” when used in the specification, specify the presence of stated features, integers, steps, operations, elements, and/or components, but do not preclude the presence of one or more additional features, integers, steps, operations, elements, and/or groups thereof.

Unless otherwise defined, all terms (including technical and scientific terms) used herein shall be given their plain and ordinary meaning as understood by one of ordinary skill in the art. It will be further understood that terms such as those defined in commonly used dictionaries, should be interpreted as having a meaning that is consistent with their meaning in the context of the relevant art and will not be interpreted in an idealized or overly formal sense unless expressly so defined herein.

The present invention may be embodied as a method, system, and/or as computer program instructions stored on a non-transitory computer-readable medium. Accordingly, the embodiments may take the form of hardware, software, or a combination thereof. Any suitable non-transitory computer-readable medium or processor-readable medium may be utilized including, for example, but not limited to, hard disks, USB Flash Drives, DVDs, CD-ROMs, optical storage devices, magnetic storage devices, etc. The instructions may be written in any suitable programming and/or scripting language, such as Java, C, C++, C#, Python, erlang, PHP, etc.

The disclosed embodiments are described, in part below, with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general-purpose computer, special-purpose computer, or other programmable data processing apparatus to produce a machine such that the instructions, which execute via the processor of the computer or other programmable data processing apparatus, create means for implementing the functions/acts specified in the block or blocks.

Note that the instructions described herein such as, for example, the operations/instructions and steps discussed herein, and any other processes described herein can be implemented in the context of hardware and/or software. In the context of software, such operations/instructions of the methods described herein can be implemented as, for example, computer-executable instructions such as program modules being executed by a single computer or a group of computers or other processors and processing devices. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, tablet computers, remote control devices, wireless handheld devices, Smartphones, mainframe computers, servers, and the like.

The term module, as utilized herein, may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code or machine code that actually implements the routines in the module. The term module may also simply refer to an application such as a computer program designed to assist in the performance of a specific task such as word processing, accounting, inventory management, etc. Additionally, the term “module” can also refer in some instances to a hardware component such as a computer chip or other hardware.

The ordered combination of various ad hoc and automated tasks in the presently disclosed platform necessarily achieves technological improvements through the specific processes described more in detail below. In addition, the unconventional and unique aspects of these specific automation processes represent a sharp contrast to merely providing a well-known or routine environment for performing a manual or mental task.

As stated herein, Independent Contractors are not provided an opportunity to perform work on both a fixed fee basis and/or an hourly price at the same time. The system of the present invention may provide an opportunity to perform multiple tasks or provide multiple services concurrently, with an associated opportunity to be paid for these services. An Independent Contractor may be eligible to earn more income per hour. The system of the present invention may further offer a Customer an opportunity to select an Independent Contractor on a fixed fee basis or an hourly basis for a particular task. The present invention differs from and distinguishes over currently existing options and may provide a system that may benefit Independent Contractors which optimizes projects available, completion of such projects, and payments therefor; and may benefit Customers by providing increased options in hiring one or more Independent Contractors for one or more projects, at either an hourly rate, or for a fixed project service fee. In accordance with the system of the present invention, Independent Contractors may complete fixed fee projects at a set price and/or hourly price services at the same time (concurrently) with a pay scale. The Independent Contractor may be provided an opportunity to work more and earn more per hour with not only multiple projects, but scheduled pay increases. The system of the present invention may solve existing problems for underpaid Independent Contractors. The system may also solve existing problems associated with heretofore inconsistent systems and methods for hiring and payment for the benefit Independent Contractors and Customers.

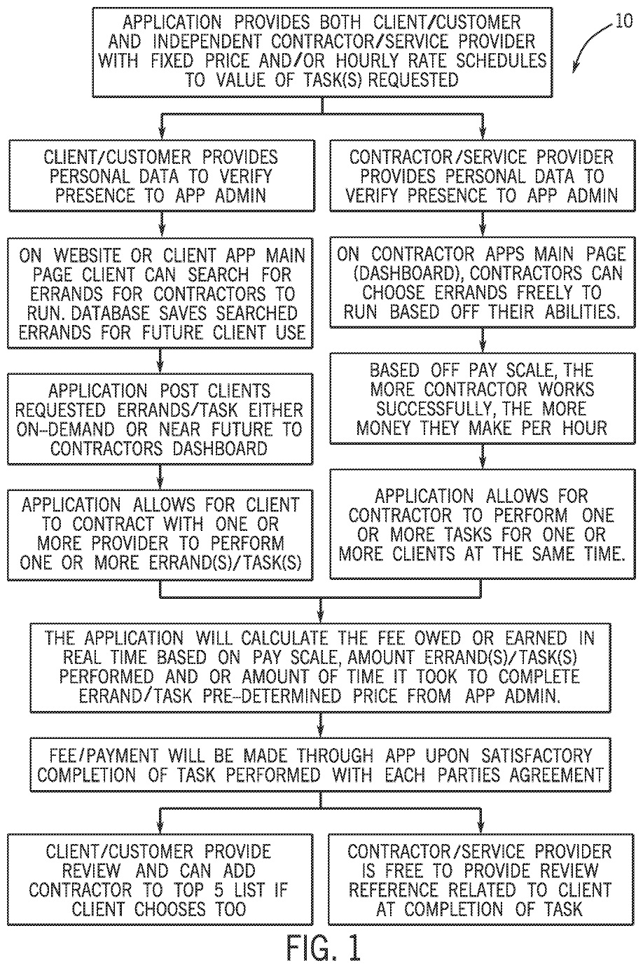

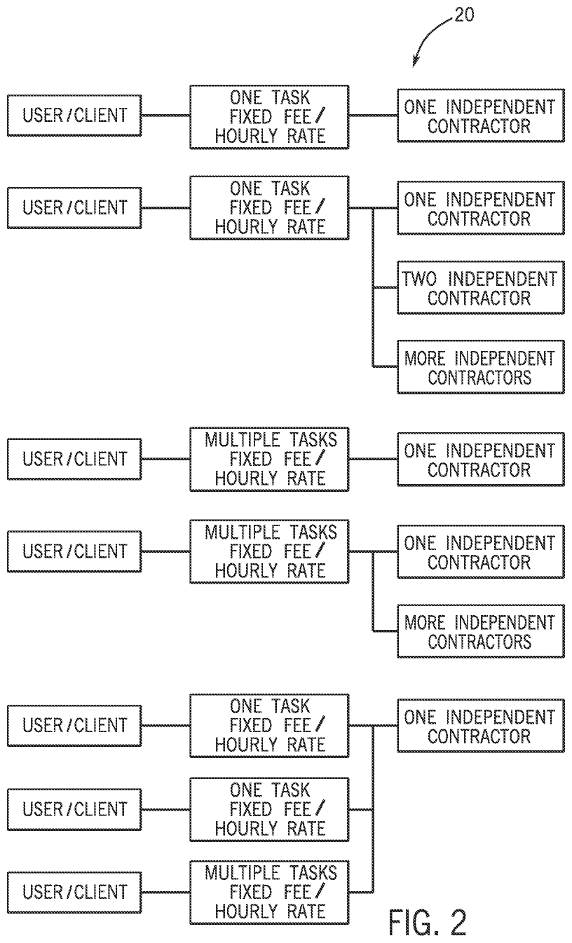

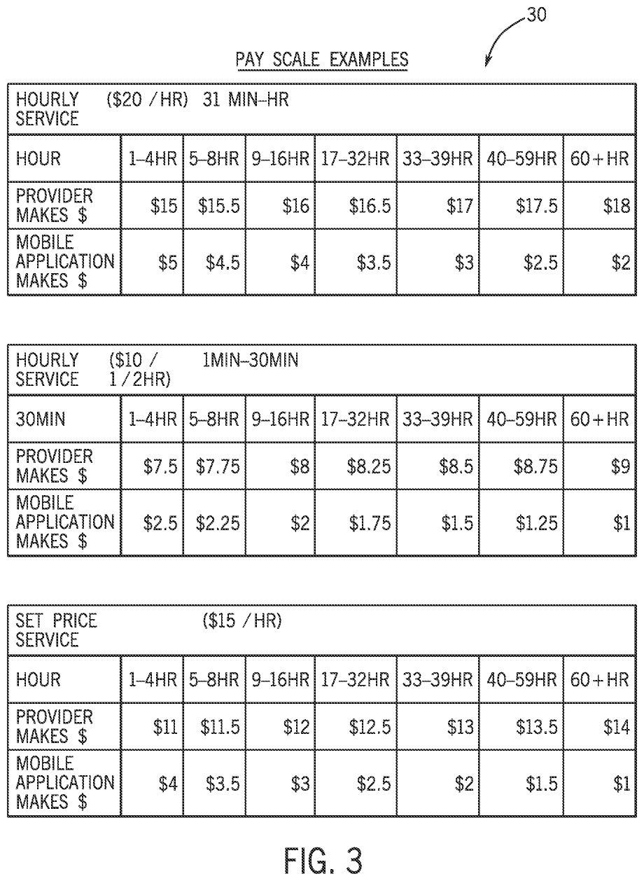

Referring now to FIGS. 1 through 3, incorporated herein by reference in their entirety, the present invention provides a mobile application and database for Independent Contractor multi-service scheduling and pay scale, and method for use. FIG. 1 is a flowchart of an exemplary embodiment of the present invention. FIG. 2 is a block diagram of an exemplary embodiment of the present invention. FIG. 3 is a chart of an exemplary embodiment of the present invention.

As shown at FIG. 1, an overall independent contractor multi-service pay scale and database mobile application process invention is shown generally at 10. The application provides both client and/or customer and independent contractor and/or service provider with fixed price and/or hourly rate schedules for the value of task or tasks which may be requested.

As shown at FIG. 2, user and/or client and independent contractor various relationships are referred to generally at 20.

As shown at FIG. 3, a table 30: shows various pay scale examples.

In an exemplary embodiment, the application system and method of the present invention may provide a personal helper that works 24/7. The system and method of the present invention may provide an unprecedented opportunity which may enable Independent Contractors to make more money per hour the more they work (pay scale) and make it possible for Independent Contractors to schedule and perform multiple tasks per hour to make more money. The system and method of the present invention may be beneficially used by Independent Contractors and Customers who use Independent Contractor service Providers. The system and method embodied in the present invention enables more efficient scheduling and payment of work by Independent Contractors and more cost-effective and efficient use of services provided by Independent Contractors for the Customers of Independent Contractors.

In an exemplary embodiment, the present invention provides an application system and method which may include one or more of the following components, elements or steps, and combinations thereof.

### Client and Independent Contractor Summary:

Client (user) may post their service requests;

Independent Contractor (Provider) may see Client (users) posts, on their dashboard;

Independent Contractor (Provider) may freely choose which service requests to fulfill, based on their abilities and availability;

Client users may designate a need for instant service or imminent service. If Client (user) need instant service or near future service, Independent Contractor (Provider) may freely choose requests.

Client (user) may hire out Independent Contractor (Provider) to run Client (user) errands via mobile request.

Independent Contractor (Provider) may select or choose a geographical service area or radius area in which they are available to run on-demand and near future services for Client (user) requests.

Depending on hours of service provided by Independent Contractor (Provider) without any cancellations of service, Independent Contractor (Provider) may be given a raise in pay per project and/or in hourly rate.

If Independent Contractor (Provider) cancels any service by Independent Contractor, their pay scale may start over at the beginning of the pay scale and their pay rate may revert to an initial pay rate.

The hourly rate of pay of an Independent Contractor (Provider) may increase after more hours are worked. In other words, hourly pay of an Independent Contractor (Provider) may increase in proportion to the number of hours worked by the Independent Contractor (Provider).

Independent Contractor (Provider) may be permitted to fulfill multiple obligations, and provide multiple services concurrently, and may provide multiple services at one time for multiple Client (user) or multiple services for one Client (user) at one time.

Independent Contractor (Provider) may be able to add another service at their own convenience after completing an active service.

Once an active service is completed an Independent Contractor (Provider) may verify completion of service.

Customers(users) may verify start and finish of service being performed.

Client (user) may request for multiple Independent Contractor (Provider) for one service.

Client (user) may also request more than one Independent Contractor (Provider) if needed for multiple service.

A “User Interface” of the system and the method in accordance with the present invention may comprise a “Multi-Service Client and Independent Contractor Flow Process” and a “Super Web Admin Panel”, which may further comprise or include at least one of the following elements or steps, and combinations thereof.

### Multi-Service Client and Independent Contractor Flow Process

### Super Web Admin Panel

### Login

### Change Password

### Register Client

Background Check Questions
See registered Customers via user interface
Option: [View, Edit, Delete, Search, Activate/Deactivate]

### Main Service Menu

An administrator may add, edit, delete entries of all types, including
Option: Set-price service like walk dog, car wash, laundry or drycleaner, pick-up/drop-off
Option: hourly pay services like hand car wash, clean, assisted/day labor, etc.
Option: [View, Add, Edit, Search, Activate/Deactivate]

### Register Independent Contractor

Background Check
See the list of registered Independent Contractor via App
Option: [Add, Edit, Search, Activate/Deactivate, Ban]

### Booking Management

Here admin may view all booking with its status: start, finish, completed, canceled, pending
Option: [List, View, Change Status, See Review Customer]

### Payment

Pending payments: View the list of pending payments Independent

### Contractor

Completed Payment: View the list of completed payments

### Pages

Set term & conditions, privacy policy & contact us page
Option: [add, edit, delete, search, activate/deactivate]

### Notifications

Commercial Advertisement
Option: [add, edit, delete]

### Setting

User
Independent Contractor

### Requests for Service

Admin may view at least one request of errand that Client needs, which may come from one or more of a Website Database+App
Option: [List View, Delete, Change, Ban]

### Report

### Logout

An exemplary embodiment of the system and method of the present invention may comprise an Independent Contractor and Client Application which may comprise a Client Application Module and may comprise or include one or more of the following components, elements or steps, and combinations thereof.

### Independent Contractor and Client Application

### Client App Functionality (Android+iPhone)

### Register [As Client]

Clients may register with basic information like e-mail, password, photo, state ID or License, medical marijuana (if valid) and phone number
Agree to platform terms

### OTP

### Login

Customer may login with [email+password] or [phone+password]

### Forgot Password

Home Screen (filter errands with filter bar)
Client may view the following options
Search bar, Booking, notification and settings

### Search Bar

Option: Client may establish or set forth any legal daily task or errand to be run by Independent Contractor
Option: Client may book the service [set price or hourly]
Option: Client may book the service [on-demand or near future]
Option: Client may request multiple errands for one Independent Contractor
Option: Client may request multiple Independent Contractor for one or more Errands
Option: Client may request multiple errands at one time for multiple Independent Contractors.
Option: Client puts details and brief description of errand Once Independent Contractor accepts errand, Client may view:
Independent Contractor detail: Client may view basic information, photo, name, tracking feature (locate).
Tracking feature (locate) is a safety feature Clients may use to view a contractor's current location.
If Client cancels booked errand, they may be charged a fee Booking (active errands/complete errands)
Here Client may view all booking with its status: start, stop, finish, cancel, completed, pending, and pay history
Option: Click “active errand” Client may contact Independent Contractor
Option: Click “active errand” Client may start or stop hourly errands.
Option: Click “active errand” then finish once errand is complete
Option: Client review performance once errand has been completed. Click “come back” (list of top 5 Independent Contractors or laborers would like to return) “good job” (job complete) “do not return” (disqualified)
Option: Once Independent Contractor accepts errand he may chat or call Client
Option: Click “complete errands” to view payment history and any app credit
Option: Once the errand is completed, payment may be done by Client using a payment gateway. Provider may be paid directly from Client account. Mobile application takes or receives a portion of pay when payment is processed.

### Notification

Commercial Advertisement
Client may view important update from Independent Contractor

### Settings

Profile Update (Client may update their profile “update options”)
Terms and Condition (Customer may view information which is uploaded by administrator or super administrator)
Privacy Policy (Customer may view information which is uploaded by super admin)
Help (contact Customer care)

### Logout

An exemplary embodiment of the system and method of the present invention may comprise an Independent Contractor and Customer Module which may comprise an Independent Contractor App Functionality for Android or iPhone systems, and may comprise or include one or more of the following components, elements or steps, and combinations thereof.

### Independent Contractor and Customer Module

### Independent Contractor App Functionality (Android+iPhone)

### Register [As Independent Contractor]

Independent Contractor may register with information like email, password, phone number, photo, State ID or License, Social Security number, Medical Marijuana Card (if valid), ages 18+, etc.
Background Check
Agree to platform terms

### OTP

### Login

Independent Contractor may login with [email+password]
may login after account has been activated by super admin

### Forgot Password

Home screen/Dashboard
Independent Contractor may view the following options
[Turn on/off button], Home Screen Dashboard, To-Do list, Notifications,

### Setting

Option: Available [turn on/off button] for availability, Independent Contractor may only receive errands when turned on.
Option: Independent Contractor may accept any errand that is available on dashboard (use search bar to narrow search)
Option: Independent Contractor may accept only errands they are capable of completing consistent with their abilities.
Option: Independent Contractor may have only a max of 4 set price errands to complete at once.
Option: Independent Contractor may accept only one hourly errand at a time, and may not add any errands while in process of running an hourly errand
Option: Independent Contractor may have only a maximum of two (2) active set price errands to be able to still except an hourly errand
   To-do List (active errands/complete errands)
Here Independent Contractor may view all booking information with status: Cancel, complete, active, earning history
Option: Click on “active errand” to call or text Client
Option: Click on “active errand” to confirm finish of hourly or set price errands
When Independent Contractor completes errand for Client
   1.Contractor may send notification to Client about completion of errand, press button like “Confirm to Finish”,
   2. Once Client receives that notification Client may mark as complete errand.
Option: Independent Contractors may be allowed to run multiple errands at one time for multiple Clients
Option: Independent Contractors may be allowed to run multiple errands for one Client at one time
Option: Independent Contractor may give review rating once errand has been done. Rating 1-5 stars
Option: Errands may require use of errands prepaid card
Option: Click on “Complete errands” to view payment history and current total amount earned
   Pay Scale (should be known to Independent Contractors)
If an Independent Contractor does not cancel any errand they chose to complete, they are given an increase in pay as followed.
If an Independent Contractor cancels any chosen errand, then their pay rate may revert to an initial rate of pay, starting back at the beginning of the pay scale.

### Notification

Commercial Advertisement
Independent Contractor may view important updates from Client

### Setting

Change radius of services area (Independent Contractor may choose geographic region or radius in which they are available for service
Profile Update (Client may update their profile “update options”)
Terms and Condition (Customer may view information which is uploaded by super admin)
Privacy Policy (Customer may view information which is uploaded by super admin)
Help (contact Customer care)
Logout

An exemplary embodiment of the system and method of the present invention may comprise a Website Database Module which may comprise or include one or more of the following components, elements or steps, and combinations thereof.

### Website Database Module

Landing page for systemic website
Page: About (Customer may view basic information about “Your App”. App screenshots
Page: Privacy Policy
Page: Contact Us
Page: Term of Condition
   Main searching
Client may visit website and search the errands database for the service that they want. Searched errands may be selected and uploaded to the systemic website's list of errands.
If a service is not available, a “request for service” option may be submitted to the database and/or stored in the database and that may be viewed via an administrator or super administrator panel in the “request for service” section.

In an exemplary embodiment, the present invention may comprise a system or method providing an Independent Contractor multi-service pay scale and database motile application which may further comprise one or more of the following elements or steps and combinations thereof.

### User Interface

### Search Bar

Option: Client may request at least one legal daily task or errand to be run by Independent Contractor
Option: Client may book the at least one service [at a set fixed price or at an hourly rate]
Option: Client may book the service [at a set time such as on-demand or near future]
Option: Client may request multiple errands be completed by one Independent Contractor
Option: Client may request multiple Independent Contractors be provided to complete one errand
Option: Client may request multiple errands be completed at one time by multiple Independent Contractors
Option: Client may enter details and brief description of errand for hire or task for completion

Once at least one Independent Contractor accepts an errand or task, Client may access and view Independent Contractor information
Independent Contractor detail: Client may view basic info, photo, name, tracking feature (locate).
Tracking feature (locate) is a safety feature Clients may use to view a contractor's current location.
If a Client cancels a booked errand the Client may be charged a fee
   Booking (active errands/complete errands)
A Client may view all booking information with its status: start, stop, finish, cancel, completed, pending, and pay history
Option: Click “active errand” Client may contact Independent Contractor
Option: Click “active errand” Client may start or stop hourly errands.
Option: Click “active errand” then finish once errand is complete
Option: Client may review performance once errand has been done. Click “come back” (list of top 5 labors would like to return) “good job” (job complete) “do not return” (disqualified)
Option: Once Independent Contractor accepts an errand the Independent Contractor may chat or call Client
   Option: Click “complete errands” to view payment history and any app Credit
Option: Once the errand is completed, payment may be done by the Client using a payment gateway. Provider may be paid directly from Client account. Mobile app may take a portion of pay when payment is process.

### Notification

Commercial Advertisement
Client may view important update from Independent Contractor

### Settings

Profile Update (Client may update their profile “update options”)
Terms and Condition (Customer may view information which is uploaded by super admin)
Privacy Policy (Customer may view information which is uploaded by an administrator or super administrator)
Help (contact Customer care)

### Logout

In an exemplary embodiment of the present invention, the system and method of the present invention may comprise one or more of the following components, elements or steps, and combinations thereof.

1. Client may request multiple fixed-fee and/or hourly services at one time for one Independent Contractor.
2. Customer may request one or more set price and/or hourly price errands or tasks for one Provider to complete.
3. Client may request multiple Independent Contractors at one time for one or more services at a fixed price and/or an hourly price.
4. Customer may request one errand or task for one or more Provider to complete.
5. Client may request multiple fix price and/or hourly price services at one time for multiple Independent Contractors.
6. Customer may request one or more set price and/or hourly price errand or task for one or more Providers to complete at once.
7. Independent Contractors may be permitted to provide multiple fixed-price services and/or hourly priced services at one time (concurrently) for multiple Clients.
8. Providers may be permitted to run one or more set price and/or hourly priced tasks or errands for one or more Customers at once (concurrently).
9. Independent Contractors may be permitted to run multiple fixed-price services and/or hourly price services for one Client at one time.
10. Providers may be permitted to run one or more set price and/or hourly price tasks or errands for one Customer.
11. If an Independent Contractor does not cancel or perform an error during any services an Independent Contractor chose to complete, the Independent Contractor may move up the pay scale and be given a pay increase.
12. Provider pay may increase the more errands the Provider runs successfully.
13. If an Independent Contractor cancels or performs an error during any chosen service, then the Independent Contractor pay may be restarted at the beginning of the pay scale (revert to the lowest pay level).
14. Provider pay may return to the start of the pay scale if the Provider runs errands unsuccessfully.
15. Client may go to website and search the errands database for the service that they want. Searched errands may be uploaded to app list of errands.
16. If a service is unavailable, it may be added or stored in the database by a request through a viewable administrator and super administrator panel in the “request for service” section.

In an exemplary embodiment of the present invention, elements, components or steps may be interrelated in the following manner.

(In components 1-6): At the Customer's discretion, the Customer may choose one or more services which may be listed at a set price or an hourly rate for one or more Independent Contractors to perform.

(In components 7-10): At the Independent Contractor's discretion, the Independent Contractor may choose one or more services for one or more Customers to perform concurrently.

(In components 11-14): The manner of operation, and process of the pay scale is explained, how the components work together to complete the invention of the process that is created.

(In components (15-16): The manner of operation, and process explaining how and where services/errands are kept in a database for future use.

In an exemplary embodiment, the process of the invention operates in the following manner. This inventive process provides Customers a more accurate picture of money owed. This process also provides Independent Contractors an opportunity to obtain and complete more work at one time (handle multiple projects concurrently), so they have an opportunity to make more money in a shorter span of time.

The process of providing a Customer the opportunity to have one or more services completed by an Independent Contractor facilitates convenience and provides the Customer fixed hourly or set price payment options. The process of providing an Independent Contractor multiple opportunities to accept one or more tasks or services to provide, such as for example without limitation, running one or more errands for one or more Customers during a short period of time with specific applicable pay scale is provided; thereby, the Independent Contractor is provided an ability to earn increased hourly compensation the more hours the Independent Contractor works continuously.

In an exemplary embodiment, the present invention may be made by the following process. A mobile application is created comprising a process of Independent Contractors running one or more fixed-price and/or hourly price services at the same time with or without a pay scale. Any pay scale may be provided. An exemplary pay scale is provided in the FIG. 3. In some embodiments, no pay scale is provided and a simple mobile application that is compatible with the multi-service process may be provided.

In an exemplary embodiment, the present invention may be used as set forth herein to solve in an unprecedented manner the problem of Independent Contractors not having the freedom to choose multiple fixed fee and/or hourly services to be completed at once or concurrently. The present invention may enable Independent Contractors to make more money per hour and produce more work per hour. The present invention may enable Independent Contractors to run multiple services concurrently, and be provided a pay scale that provides pay increases based on steady production: the more an Independent Contractor may work per hour, the more they may make per hour. The more an Independent Contractor may work continuously, the more the applicable pay rate may increase based on the pay scale.

In summary, in an exemplary embodiment, the present invention may comprise a mobile application and database for Independent Contractor multi-service scheduling and pay scale, and method for use. The Independent Contractor multi-service pay scale and database mobile application system, and process or method may facilitate generation of multiple leads for hourly and per-project basis work. The system and method may be beneficially used by Independent Contractors and Customers, and may increase productivity of Independent Contractors, and result in more efficient and cost-effective use of Independent Contractors by Customers.

Unless otherwise stated, the foregoing alternative embodiments are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the embodiments described herein, as well as clauses phrased as “such as,” “including,” and the like, should not be interpreted as limiting the subject matter of the claims to the specific embodiments; rather, the embodiments are intended to illustrate only one of many possible embodiments.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for determining a pay scale for providing two concurrent tasks, the method comprising:
receiving from a client device, task data for one or more hourly tasks and one or more fee tasks, wherein the task data comprises:
a valuation rate and a fee valuation, respectively, for each task;
an instant task type or imminent task type for each task; and
a status condition for each task, wherein the task data is entered into an interface displayed on the client device;
presenting a task display of each task on a user interface of each of a plurality of user devices, wherein each task display includes to a plurality of status indicators comprising started, pending, and cancelled; and
causing real-time pay scale for the hourly task to be displayed on the user interface of the one user device based on an amount of time from when the started status indicator is selected on the identified client device.

2. The method of claim 1, further comprising:
receiving, at the user device, an indication of a time quantity and/or an amount quantity of the valuation rate determined via the client device.
